(19) United States
(12) Patent Application Publication
(10) Pub. No.: US 2008/0007080 A1
(43) Pub. Date: Jan. 10, 2008

(54) Clip With Dual Attachment Channels and Corresponding Clip House

(75) Inventors: Renji Maki, Brookville, OH (US); Norihisa Kataya, Obu-City (JP); Fumiaki Uchimura, Obu-City (JP)

Correspondence Address: WEGMAN, HESSLER & VANDERBURG, 6055 ROCKSIDE WOODS BOULEVARD, SUITE 200, CLEVELAND, OH, 44131, US

(73) Assignee: Green Tokai Co., Ltd., Brookville, OH (US)

(21) Appl. No.: 10/581,118

(22) PCT Filed: Mar. 30, 2004
(86) PCT No.: PCT/US04/09495

§ 371 Date: Sep. 13, 2007

Related U.S. Application Data
(60) Provisional application No. 60/530,554, filed on Dec. 18, 2003.

(51) Int. Cl. F16B 5/12

(52) U.S. Cl. 296/29

(57) ABSTRACT

A Clip (1) and a clip house (20)for an automotive part. The clip (1) has dual attachment channels (4,5) so that the clip (1) is easily attachable, removable and re-attachable to and from a vehicle, such as an automobile, boat, snowmobile, or other similar structure. The clip (1) comprises a base (2), whereby a male member (3) projects from the base of the clip (2) on one side of the base (2), and the channels (4, 5) extend from the base (2) on the opposite side of the base (2). A longitudinal axis (b) of the male member (3) is offset slightly from a true center (a) of the base (2). The channels (4, 5) are provided on the side of the base (2) opposite the male member (3). Flanges (7, 8) are provided to secure attachment means of a trim part (30) received in the channels (4, 5). The clip house (20) comprises a ramp (85) with a recessed well (23) parallel to the ramp (85). One of the channels (4, 5) of the clip (1) slides along the ramp (85) to snap lock one of the flanges (7, 8) in secured, engaged attachment to the clip house (20).

### CROSS-REFERENCE TO RELATED APPLICATION

This application claims the benefit of U.S. Provisional Patent Application Ser. No. 60/530,554 filed Dec. 18, 2003.

### BACKGROUND OF THE INVENTION

1. Field of Invention

This invention relates to clips having dual attachment channels for use with trim parts having a corresponding clip house. The clips secure the trim part to a vehicle, such as an automobile, boat, snowmobile, or the like by attachment of the clip to a clip house joined with the trim part.

2. Description of Related Art

Several types of vehicular body or trim clips are known. In many instances, special clips have to be designed and made to suit each unique trim part/mounting surface structure. This requirement results in an increase in engineering and manufacturing time. It is therefore desirable to provide a versatile clip that may accommodate a variety of different trim part/mounting surface structural designs.

### SUMMARY OF THE INVENTION

This invention provides a versatile clip with dual attachment channels that is easily attachable, removable and re-attachable to and from a vehicle, such as an automobile, boat, snowmobile, or the like.

This invention separately provides a clip comprising a base, wherein a male member projects from the base of the clip on one side of the base, and dual attachment channels are formed along opposing sides of the base. The longitudinal axis of the male member is offset slightly from the center of the clip base. Rounded protuberances extend from two sides of the male member and are slightly spaced above the clip base. Each of these protuberances or raised surfaces is raised slightly from an upper surface of the clip base to form a gap between a lower surface of the protuberances and an upper surface of the clip base. In this configuration, the raised, rounded portions and the upper surface of the base cooperate to secure the clip to the vehicle by snug receipt of sheet metal, or other mounting surface of the vehicle, into the gap.

Various exemplary embodiments of this invention separately provide dual attachment channels formed in the clip base opposite from the male member. The dual attachment channels are offset relative to a line bisecting the base. Each attachment channel is formed as a substantially u-shaped channel in the clip base. Portions of a corresponding clip house are received in the channels, and flanges provided on outer edges of the channels secure the clip in place on the clip house. The clip house is joined with the trim part and is preferably co-molded therewith. Thus, securing the clip to the clip house permits the trim part to be removably mounted to the vehicle using the same clip as desired.

As a result of the exaggerated offset of the dual attachment channels relative to the center of the clip, one of the attachment channels is deeper than the other attachment channel. As a result, increased versatility of the clip is achieved as the clip may be oriented for one attachment channel to receive a correspondingly sized portion of the clip house, whereas the other attachment channel may be positioned to receive a different sized portion of the clip house. In this sense, the clip is quite versatile for use with vehicle trim parts having differently oriented or differently sized clip houses.

According to various exemplary embodiments of the clip, a first flange is provided at an outer edge of the first attachment channel. The first flange may be located at the outer edge on either the upper or lower side of the first channel. The second attachment channel may include a second flange also at an outer edge of the second channel. The first and second flanges are thus oriented on the same upper or lower sides of their respective first and second channels, or may be oriented on opposite upper and lower sides of the first and second channels. The clip is secured to a longitudinally extending upper surface of the clip house by inserting a raised portion of the upper surface of the clip house into the first channel, for example. The clip is thus mounted to the clip house in a direction transverse to the longitudinal extent of the upper surface of the clip house. In this manner, the clip thus snaps or friction fits the first flange into a well just beyond a raised portion on the upper surface of the clip house.

Alternatively, the clip is secured by longitudinally sliding the first and second channels of the clip onto a slotted clip house, thus positioning the first flange in a well just beyond a raised portion in the upper surface of the clip house and positioning the second flange along a flared outer edge of the upper surface of the clip house. The slot receives a common wall of the clip that separates the first and second channels. Thus, one attachment channel slides over a solid upper surface of the clip house to secure the clip to the clip house, or both attachment channels are slid along a slotted upper surface of the clip house in order to secure the clip in place.

In various exemplary embodiments, the flanges on each of the dual attachment channels may be oriented in the same direction as one another, i.e., both protruding upwardly toward the male projection or downwardly away from the male projection, or the flanges may be oriented in opposite directions; i.e., one flange may protrude upwardly toward the male projection and the other flange may protrude downwardly away from the male projection. In either case, the flanges serve to secure the clip to the clip house that is joined with the trim part that is to be attached to a vehicle, boat, or the like.

One exemplary embodiment of the clip house according to the invention comprises a clip house joined with and projecting from the interior of the trim part. The upper surface of the clip house includes a raised portion over which the flange of the first channel, for example, rides to position the clip onto the clip house. Just beyond the raised portion, a recessed well is provided in which the flange of the first channel will rest once the clip has been appropriately snap or friction fitted onto the clip house. Reinforcement ribs join the clip house to the trim part and provide rigidity to the clip house. In this exemplary embodiment, it is possible that only one of the attachment channels is used to secure the clip to the clip house.

Another exemplary embodiment of the clip house according to the invention comprises a clip house joined with and projecting from the interior of the trim part. In this embodiment, a slot is provided near a rear portion of the upper surface for receiving the common wall separating the first and second channels of the clip. As the clip is slid into the slot, and thus onto the clip house, one flange of the clip engages the rear edge of the upper surface, and another flange of the clip seats in the well just beyond a raised portion towards a front of the upper surface. A single side wall joins the clip house to the interior of the trim part and provides rigidity to the clip house. Thus, the clip house of this embodiment is closed on one side by the single side wall, and open on the other side to enable the first and second channels of the clip to slidably receive the upper surface of the clip house.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail with reference to the following figures, wherein:

FIG. 1 illustrates a perspective view of a clip according to the invention;

FIG. 2 illustrates a right hand side elevational view of one exemplary embodiment of the clip shown in FIG. 1;

FIG. 3 illustrates a right hand side elevational view of another exemplary embodiment of the clip shown in FIG. 1;

FIG. 4 illustrates a left hand side elevational view of the clip shown in FIGS. 1 and 2;

FIG. 5a is a view similar to FIG. 2 but showing secure attachment of automotive mounting surfaces in one of the attachment channels of the clip; and

FIG. 5b shows another view of one of the attachment channels of the clip attached to the automotive mounting surfaces.

### DETAILED DESCRIPTION

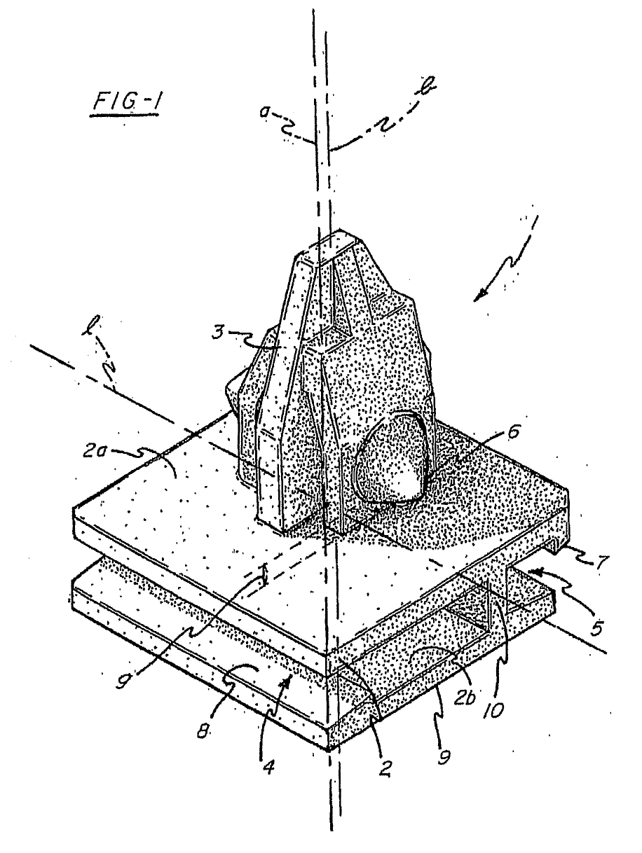

Turning first to FIG. 1, there is shown a versatile clip in accordance with the invention. The clip comprises a base member 2 having an upper portion 2a and lower portion 2b arranged generally in parallel to each other and defining a top surface and a bottom surface, respectively. A male member 3 projects upwardly from the top surface 2a and, as shown, the member 3 projects perpendicularly from the upper surface 2a. First and second channels 4, 5, respectively, are formed in the base and have open ends parallel to flange members 7 and 8. The open ends of the first and second attachment channels face in opposite directions from each other.

Raised portions 6 are provided on both the right and left sides of the male member 3. The raised portions 6 are in the form of a smooth, curved, radiused surface, and the space between the upper surface 2a and the raised portions 6 defines a gap g into which a vehicular mounting surface, such as sheet metal or the like, will be grasped firmly.

As shown, common wall 10 separates the first and second channels from each other. The bottom surface of the base is depicted as 9 in FIG. 1.

The base comprises a central axis shown as line (a), projecting perpendicularly through the clip. A longitudinal axis L is also shown in perpendicular relation to central axis (a). The longitudinal axis L bisects the base into equal areas. As shown, the male member has a central axis (b), that is parallel to the central axis of the base (a) but eccentrically mounted therefrom.

It is noted that the channels 4 and 5 extend in generally parallel relation to the longitudinal axis L with the common wall member 10 being laterally spaced from the longitudinal axis. Accordingly, the channels 4, 5 are offset with regard to the longitudinal axis L of the base. Each of the channels has a different depth so that in order to enhance the versatility of the clip, the channels 4, 5 may accommodate differently dimensioned mounting structures of the vehicle. This, along with the eccentric mount of the male member 3 on the base, greatly increases the versatility of the clip as compared to conventional clips in which attachment channels may be provided in symmetrical disposition along the clip surface.

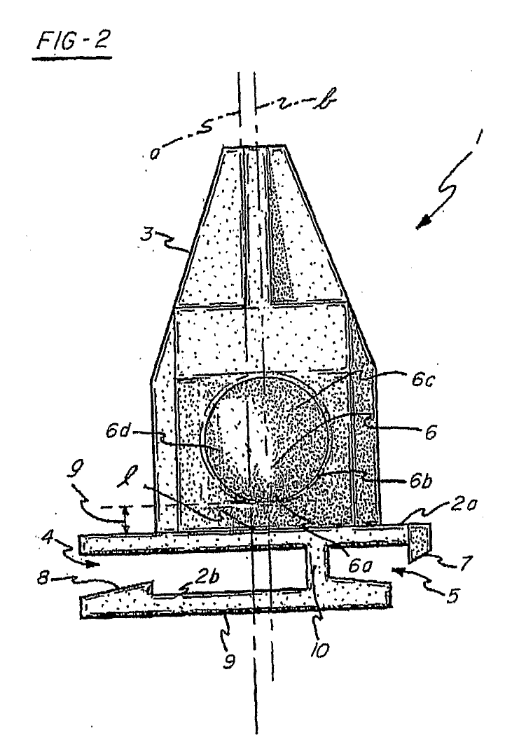

FIG. 2 clearly shows the employment of opposing flange members 7, 8 that are respectively provided in conjunction with the channels 5, 4. Here, flange 7 protrudes downwardly from the upper portion 2a of the base with flange 8 provided in the channel 4 projecting upwardly from the lower portion 2b of the base. The flanges provide narrowed constrictions along each of the channels and are accordingly useful in a friction fit of the requisite mounting surfaces in the respective channels 4, 5.

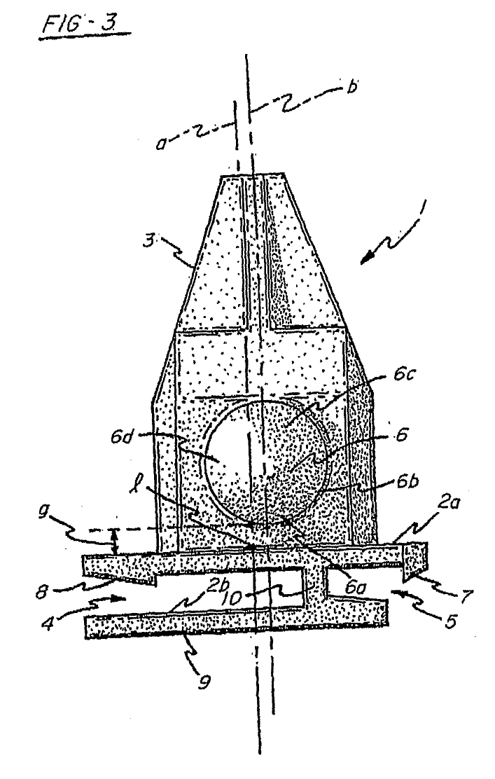

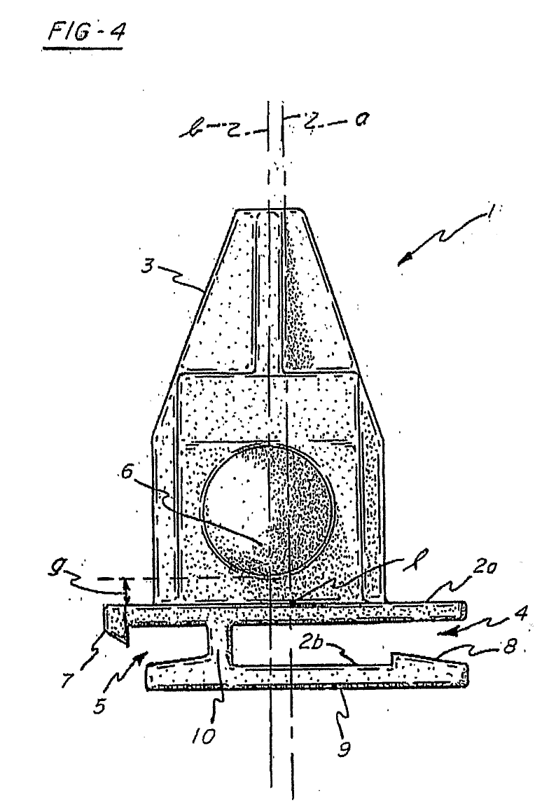

FIGS. 2 thru 4 more clearly show the offset relationship between the channels 4, 5, wherein FIGS. 2 and 4 show right and left side views of a first exemplary embodiment of the clip, and FIG. 3 shows a right side view of a second exemplary embodiment of the clip. That is, the channels 4, 5 in the clips of FIGS. 2 thru 4 are both parallel to the longitudinal axis L, but the common wall 10 separating the two channels is laterally offset from this longitudinal axis. As shown, the open faces of the respective channels 4, 5 are disposed in opposition to each other and, as shown, these open faces are disposed at 180° to each other. The distinguishing feature between the various embodiments shown in FIGS. 2 thru 4 lies in the positioning of the flange 8. In FIGS. 2 and 4 the flange 8 is provided on an upper side of the lower portion 2b of the base, whereas in FIG. 3 the flange 8 is provided on a lower side of the upper portion 2a of the base.

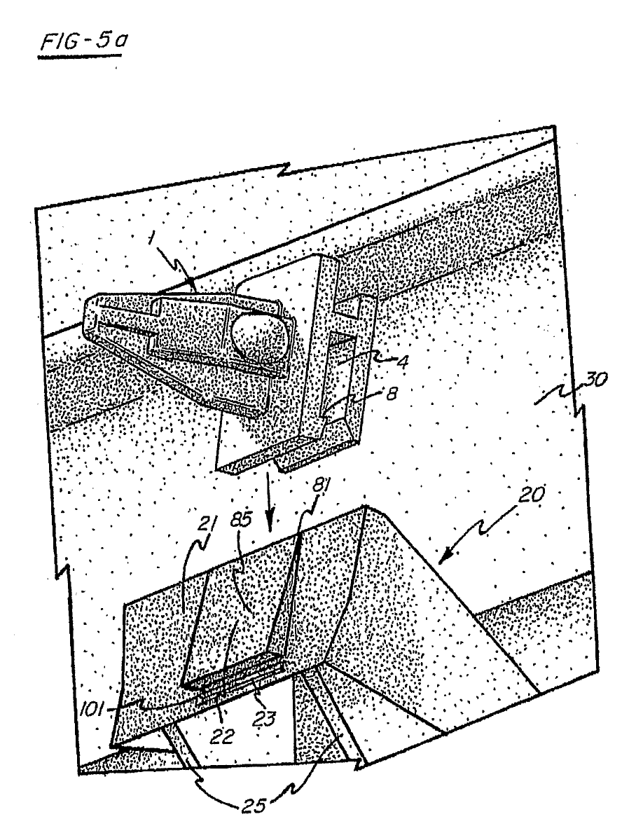

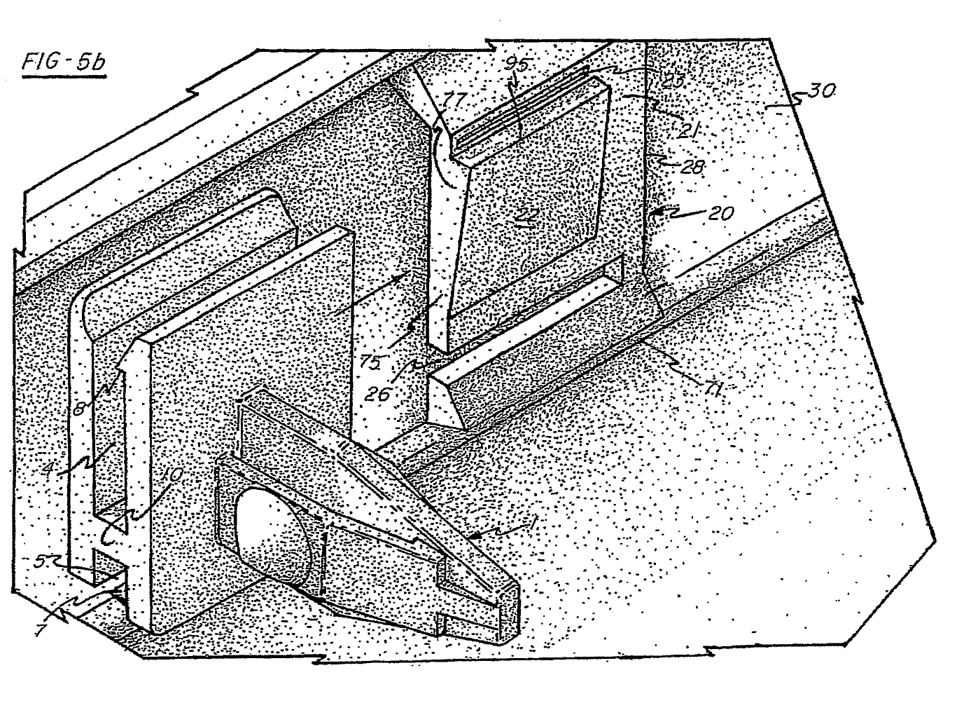

FIG. 5a illustrates one exemplary embodiment of the clip house 20 mounting surface adapted for engagement with clip 1 according to the invention. The clip house 20 projects from an interior of the trim part 30 and as shown is integral with the trim part 30. Reinforcing ribs 25 further join the clip house 20 to the trim part 30 and provide rigidity to the clip house 20.

The upper surface 21 of the clip house 20 includes an inclined portion 22 over which the flange 8 of the first channel, for example, slides to position the clip 1 onto the clip house 20. Just beyond the raised portion 22, a recessed well 23 is provided into which the flange 8 of the first channel will rest once the clip 1 has been appropriately snap or friction fitted onto the clip house 20. In this exemplary embodiment, the clip 1 is thus mounted to the clip house 20 by sliding the clip 1 onto the clip house 20 in a direction generally transverse to the longitudinal direction of the upper surface 22 of the clip house 20 in order to secure the clip 1 to the clip house 20.

The inclined portion of the mounting surface is in the form of a ramp having a base section 81 and an elevated section 85 which terminates in edge portion 101. The recessed well 23 is positioned adjacent edge 101 with the edge and recessed well 23 being in generally parallel relation along the longitudinal axis or dimension of the part.

FIG. 5b illustrates another exemplary embodiment of the clip house 20 corresponding to an exemplary clip 1 according to the invention. In the embodiment of FIG. 5b the clip house 20 is joined to and extends from the interior side of the trim part 30. In this embodiment, the upper surface 21 of the clip house 20 is provided with a slot 26 through which the common wall 10 of the clip 1 longitudinally slides to position the first and second channels 4, 5 as desired on the clip house 20. The upper surface 21 is also provided with a raised portion 22 that extends to a side edge of the upper surface 21. As the clip 1 is slid into the slot 26, and thus onto the clip house 20, one flange 7 of the clip 1 engages rear edge 71 of the upper surface 21, and another flange 8 of the clip 1 seats in the well 23 just beyond the raised portion 22 of the upper surface 21. In this embodiment, the raised portion 22 extends to a side edge of the upper surface 21 of the clip house 20 in order to properly align the clip 1 as it is being slid onto the clip house 20. A web like side wall 28 joins the clip house 20 to the trim part 30. The clip house 20 of this embodiment is thus partially closed on one side and open on the other side to enable the first and second channels of the clip to slidably receive the upper surface of the clip house. Preferably, in all of the embodiments described herein, the clip house 20 is integrally molded with the trim part 30, although the artisan will appreciate that joining the clip house 20 with the trim part 30 may be achieved otherwise without compromising the features and novelties of the clip and corresponding clip house of the invention described herein.

Similar to the structure shown in FIG. 5a, the mounting surface of the clip house shown in FIG. 5b is in the form of a ramp wherein the ramp comprises a base edge portion 75 and an elevated portion 77. The elevated portion of the ramp terminates in an edge 95 that extends above the well 23 and is substantially parallel thereto along the longitudinal axis of the part. In this embodiment, the ramp is interposed between the channel 26 and the well 23.

It is then apparent in conjunction especially with FIGS. 5a and 5b that the clip and clip house combination in accordance with the invention are extremely versatile. For example, in the embodiment shown in FIG. 5a, the clip is inserted via a force vector shown by the arrow in FIG. 5a which is transversely preferably normally related to the longitudinal axis of the part 30. The attachment channel and associate flange 8 of the clip are slid along the ramp 85 with the flange 8 then extending over edge 101 of the ramp and then being anchored firmly in the recessed well 23. At the same time, the flange 7 (see FIG. 1) abuts the base edge 81 of the ramp to help prevent rotation of the clip that may otherwise occur.

The embodiment shown in FIG. 5b results in a clipping action wherein the clip is inserted in its mating clip house structure by a force vector exerted in the longitudinal direction of the part as shown by the arrow. Here, the attachment channel 4 and associated flange 8 of the clip slide along the ramp with the flange 8 extending over the edge 95 of the clip house for firm securement in the recessed well 23. At the same time, the common wall 10 is snuggly received in channel 26 of the clip house and the flange 7 formed in the second channel of the clip extends under the edge portion of the clip house structure shown at 71 in FIG. 5b so as to once again, help to inhibit pivoting of the clip that may otherwise occur.

While this invention has been described in conjunction with the specific embodiments described above, it is evident that many alternatives, combinations, modifications, and variations are apparent to those skilled in the art. Accordingly, the preferred embodiments of this invention, as set forth above, are intended to be illustrative only, and not limiting. Various changes can be made without departing from the scope and spirit of this invention.

1. A clip adapted for attaching a trim part surface to a mounting surface of a vehicle, said clip comprising:
a base having a top and bottom portion;
a male member extending outwardly from said top portion of said base, raised surface portions formed on opposing sides of said male member with a gap being defined between said raised portions and said top of said base, said gap adapted for snug receipt of said mounting surface of a vehicle therein;
a first attachment channel formed in said base;
a second attachment channel formed in said base;
said first and second attachment channels being in generally parallel relation to each other in said base and separated by a common wall extending between said top and said bottom portions of said base, said first and second attachment channels having elongated openings, said elongated openings in said first and second attachment channels facing in opposing directions.

2. The clip as recited in claim 1, wherein said male member comprises a longitudinal axis, said base comprising a central axis, and wherein said male member is eccentrically positioned relative to said central axis on said base.

3. The clip as recited in claim 1, wherein said base comprises a longitudinally extending axis perpendicularly related to said central axis of said base and bisecting said base, and wherein said common wall extends parallel to and is laterally spaced from said longitudinal axis.

4. The clip as recited in claim 3 further comprising a flange area providing a narrowed portion in one of said attachment channels.

5. The clip as recited in claim 3 wherein each of said first and second attachment channels comprise a flange area therein, thereby narrowing a portion of each attachment channel.

6. The clip as recited in claim 5, wherein said flanges face opposing directions.

7. The clip as recited in claim 6, wherein the flanges face in a same direction.

8. The clip recited in claim 1, wherein said raised surface portions of said male member present smoothed, radiused surfaces.

9. Composition comprising a clip and a clip house for engaging said clip;
said clip house being attached to an automotive trim part and comprising an inclined mounting portion;
said clip comprising:
a base having a top and bottom portion;
a male member extending outwardly from said top portion of said base, raised surface portions formed on opposing sides of said male member with a gap being defined between said raised portions and said top of said base, said gap adapted for snug receipt of said mounting surface of a vehicle therein;
a first attachment channel formed in said base;
a second attachment channel formed in said base;
said first and second attachment channels being in generally parallel relation to each other in said base and separated by a common wall extending between said top and said bottom portions of said base, said first and second attachment channels having elongated openings, said elongated openings in said first and second attachment channels facing in opposing directions;
one of said attachment channels of said clip slidably engaging said inclined portion of said clip house thereby securing said clip to said clip house.

10. Combination as recited in claim 9 wherein said clip house further comprises a recessed well adjacent said inclined mounting portion, said clip further comprising a flange area in said first attachment channel providing a narrowed end portion in said first attachment channel, said flange area being snuggly fit into said recessed well upon sliding movement of said clip relative to said clip house.

11. Combination as recited in claim 10 wherein said clip house comprises a slot, said common wall of said clip being slidably engaged in said slot.

12. Combination as recited in claim 11, said clip comprising a second flange formed in said second attachment channel, said clip house further comprising an edge of said mounting surface, said second flange of said clip extending over said edge.

13. Combination as recited in claim 10, wherein said inclined mounting surface of said clip house defines a ramp having a base portion and an increased elevation portion, said recessed well portion of said clip house being adjacent said increased elevation portion of said ramp.

14. Combination as recited in claim 11, wherein said inclined mounting surface of said clip house defines a ramp having a base portion and an increased elevation portion of said clip house, said recessed well portion of said clip house being adjacent said increased elevation portion of said ramp.

15. Automotive trim part of the type having a show surface and a rear surface opposite said show surface, said rear surface comprising a clip house mounting structure thereon for receiving a clip therein to attach said part to a frame member or the like, said clip house comprising an inclined mounting portion in the form of a ramp, said ramp having a base portion and an elevated portion, said clip house also including a recessed well portion extending adjacent said elevated portion of said ramp.

16. Clip house mounting structure as recited in claim 15 further comprising a channel formed in mounting surface, said ramp being interposed between said channel and said recessed well.

17. Clip house mounting structure as recited in claim 16 wherein said recessed well and said channel extend along a longitudinal dimension of said part in substantially parallel relation to each other and wherein said elevated portion of said ramp terminates in an edge surface that is substantially parallel to said recessed well.

18. Clip house mounting structure as recited in claim 14 wherein said elevated portion of said ramp terminates in an edge surface that is substantially parallel to said recessed well.
